(19) United States
(12) Patent Application Publication
(10) Pub. No.: US 2018/0268649 A1
(43) Pub. Date: Sep. 20, 2018

(54) USER INTERFACE FOR ELECTRONIC GAMES

(71) Applicant: James Plescia, Granada Hills, CA (US)

(72) Inventor: James Plescia, Granada Hills, CA (US)

(21) Appl. No.: 15/815,086

(22) Filed: Nov. 16, 2017

Related U.S. Application Data
(60) Provisional application No. 62/471,301, filed on Mar. 14, 2017.

(51) Int. Cl. G07F 17/32

(52) U.S. Cl. CPC G07F 17/3246; G07F 17/3297; G07F 17/3209; G07F 17/3211

(57) ABSTRACT

An electronic game and method of operating the same are disclosed. The electronic game is of the type requiring manual inputs by a player to electrical apparatus. A payment acceptance apparatus is operable by the same game play input apparatus as that used to receive and process the inputs to play the game. The electronic game may include a display operable to display queries and instructions for the player. The game may be for example a miniature crane operable to grasp and retrieve objects from an object storage area of the electronic game, responsive to manipulation of the crane by manual inputs by the player.

### REFERENCE TO RELATED APPLICATION

The present application claims priority to U.S. Provisional Application Ser. No. 62/471,301, filed Mar. 14, 2017.

### FIELD OF THE DISCLOSURE

The present disclosure relates to user control arrangements for electronic games requiring manual inputs from a player of an electronic game.

### BACKGROUND

Electronic games have been made available in arcades, shopping centers, and other commercial venues for public amusement. These games particularly include those requiring periodic manual inputs to control game elements. Examples include manipulation of small cranes to retrieve objects, target type games in which the player attempts to use a physical or virtual weapon, simulated sports games, and other games requiring physiological motor skills and reaction to virtual or recreated events.

Many such games include a cabinet, a screen, real or virtual game apparatus which may be displayed on the screen, or which may be physical game apparatus, and a payment acceptance module mounted in the cabinet. A prospective player inserts payment into the payment acceptance model, and proceeds to play the game. The game may issue tangible or imaginary rewards. Tangible rewards may include physical objects such as miniature models of objects, stuffed animals, symbolic value such as scrip, tokens, or payment cards usable as value for additional play. Imaginary rewards may include scores displayed on the screen.

The payment acceptance module typically is self-contained, having its own controls such as pushbuttons. Its operation is generally divorced from that of the game itself. Because the operator of the electronic game will likely not want to impinge on the game apparatus, the payment acceptance module is typically placed in a location on the cabinet which is awkward or uncomfortable to reach.

There exists a need to improve the payment acceptance aspect of electronic games. Notably, it is desirable to improve the location of at least the controls of the payment acceptance module. Also, it would be desirable to improve the payment process of game play to more effectively entice potential players to play. It is also desirable to reduce the size and cost of the payment acceptance module.

### SUMMARY

The disclosed concepts address the above stated situation by utilizing pre-existing game controls to also serve the payment process. This may be done in part by displaying prompts on the screen to guide those unfamiliar with an electronic game not having apparent payment controls.

For example, an electronic game awaiting a player may display a prompt such as “press here to play” or “move the joystick to play”. Performance by a prospective player of the specified action may then initiate further prompts to effect payment, display play options, and to actually play the game.

This arrangement eliminates any requirement that a payment acceptance module have its own dedicated manual controls. By relying on game controllers, this arrangement causes the prospective player to enjoy more comfortable manipulations when operating payment acceptance apparatus. Beyond that, mere placement of a prospective player's hands on actual game controls may entice a player to play the game, or to play more.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a schematic perspective view of an electronic game system, according to at least one aspect of the disclosure;

FIG. 2 is a plan view of an optional value bearing card usable with the electronic game system of FIG. 1;

FIG. 3 is a block diagram of steps of a method of operating an electronic game, according to at least one aspect of the disclosure;

FIG. 4 depicts an exemplary screen of the electronic game system, illustrating use of the screen to guide a player in making payment in order to play a game;

FIG. 5 depicts an exemplary screen of the electronic game system, illustrating use of the screen to process payments for playing the game;

FIG. 6 depicts an exemplary screen of the electronic game system, illustrating use of the screen to prompt the player to use a joystick to implement payment steps necessary to play the game; and

FIG. 7 depicts an exemplary screen of the electronic game system, illustrating use of the screen to instruct a player to use the same joystick to actually play the game.

### DETAILED DESCRIPTION

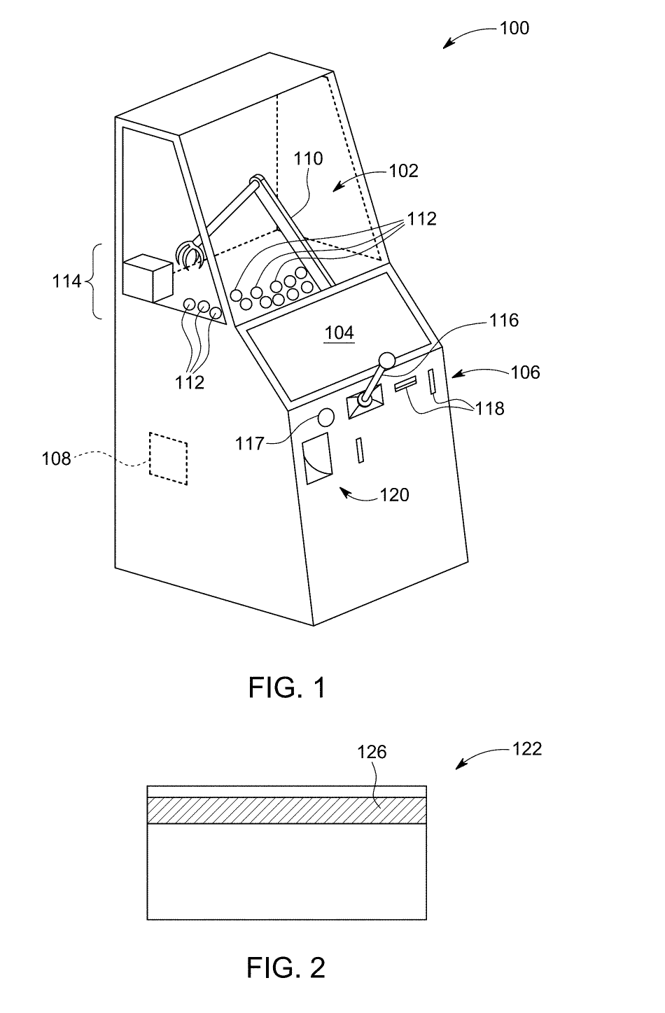

Referring first to FIG. 1, according to at least one aspect of the disclosure, there is shown an electronic game system 100 for operating an electronic game by a player (not show). Electronic game system 100 may comprise a game apparatus 102 operable to enable the player to play a predetermined game, manual game play input apparatus operating as an interface for receiving manual inputs corresponding to commands, a display screen 104, payment acceptance apparatus 106, and a microprocessor 108. Microprocessor 108 may include a memory having computer instructions loaded therein in a non-transitory computer-readable medium that when executed, are configured to instruct microprocessor 108 to operate game apparatus 102 to play the game, to receive the manual inputs from the manual game play input apparatus, to control display screen 104, and to operate payment acceptance apparatus 106. The same manual game play input apparatus which receives inputs to operate game apparatus 102 to play the game also receives inputs to operate payment acceptance apparatus 106. It will be understood that microprocessor 108 is provided with a suitable power supply (not shown, but which could comprise a connection to external AC electrical power, and an AC-to-DC power converter) and conductors to other components of electronic game system 102 to enable operation as described herein.

The game is predetermined in that it is stored in a memory of microprocessor 108, and has predetermined rules, playing procedures, and the like.

Game apparatus 102 may be for playing any of many diverse types of games, including small cranes to retrieve objects, target type games in which the player attempts to use a physical or virtual weapon, simulated sports games, and other games requiring physiological motor skills and reaction to virtual or recreated events. Accordingly, the manual game play input apparatus operating as an interface for receiving manual inputs corresponding to commands may comprise levers, touchscreens (none of these is shown), a joystick 116, a pushbutton 117, or any combination of these. Joystick 116 and pushbutton 117 are ordinarily used in some crane type games.

As illustrated in the present example of electronic game system 100, game apparatus 102 is of the type including a small crane 110 to retrieve objects 112. Game apparatus 102 may comprise a play region 114 containing at least one graspable free object 112, and crane 110 configured and operable to reach into play region 114 and grasp and raise at least one graspable free object 112. In this type of game, the player manipulates joystick 116 to control crane 110 to grasp and retrieve objects 112. Grasped objects 112 may be released from grasp, e.g., to deposit in a hatch (not shown) for determining a score by depressing pushbutton 117. Objects 112 may be balls for example. Ordinarily, the object of the game is to successfully retrieve as many objects 112 as possible within a predetermined time interval.

Payment acceptance apparatus 106 may comprise slots 118 for insertion of currency, credit and debit cards, or other value bearing instruments (none shown). Payment acceptance apparatus 106 may be generally conventional in its structure and operation, apart from being controlled by the manual game play input apparatus, and need not be set forth in further detail herein.

Electronic game system 100 may comprise a dispenser 120 configured and operable to dispense a prize (not shown) to the player. The computer instructions of microprocessor 108 may be configured to instruct microprocessor 108 to dispense the prize to the player when the player has attained a predetermined degree of success when playing the game.

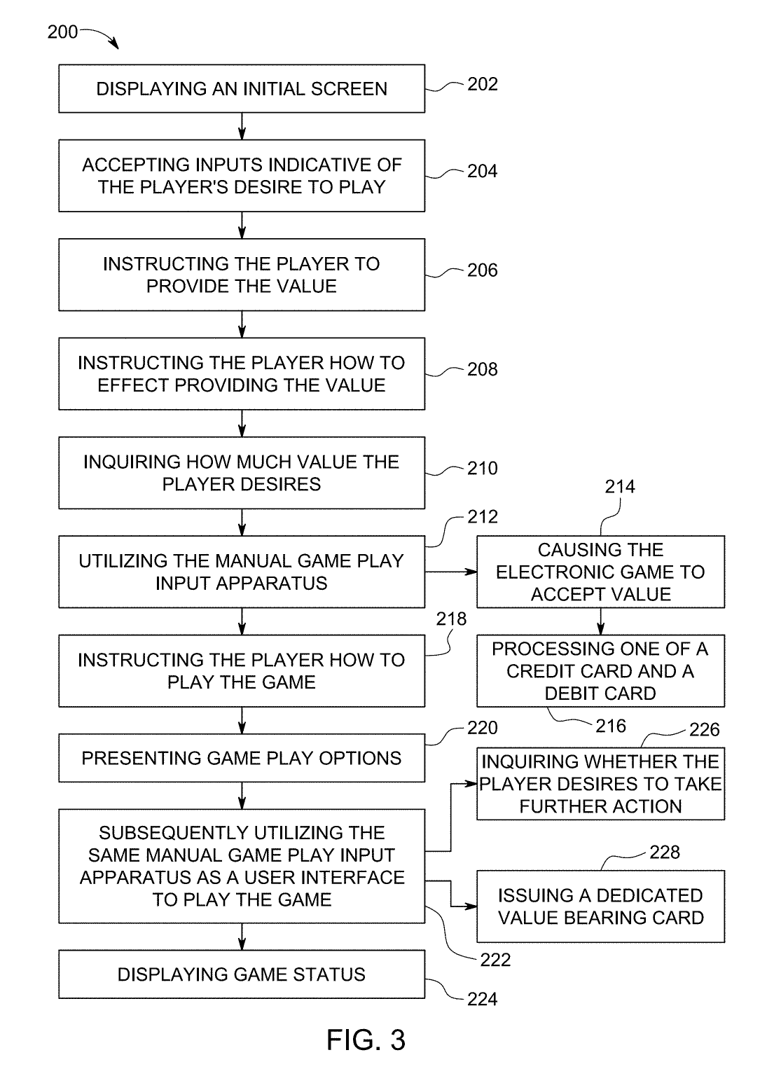

In addition to electronic game system 100, the invention may be thought of as a method 200 of operating an electronic game, method 200 utilizing the apparatus of FIG. 1. As used herein, “operating” the game refers to administrative steps undertaken by the apparatus of electronic game system 100, rather than referring to actual play by a player. Steps of method 200 are summarized in FIG. 3. In method 200 of operating the electronic game by a player, the electronic game may have manual game play input apparatus for accepting player commands necessary to play the game. Method 200 may comprise utilizing the manual game play input apparatus as a user interface to process inputs necessary to initiate game play (step 212), and subsequently utilizing the same manual game play input apparatus as a user interface to play the game by having the player enter manual game move inputs to the manual game play input apparatus (step 222). In the example of FIG. 1, the manual game play input apparatus, used for both initiating game play (e.g., by processing payment by payment acceptance apparatus 106 and performing any other administrative task requiring manual player input) and also for actually playing the game (e.g, to control crane 110), may comprise joystick 116.

In the method, initiating game play may comprise causing the electronic game to accept value in exchange for making the game available to a player, wherein causing the electronic game to accept value comprises utilizing the manual game play input apparatus to operate value acceptance by electronic game system 100 (step 214).

In the method, causing the electronic game to accept value may comprise processing one of a credit card and a debit card, utilizing the manual game play input apparatus as a user interface in processing the credit card or debit card (step 216).

Method 200 may comprise issuing a dedicated value bearing card 122 (FIG. 2) to the player (step 228). Dedicated value bearing card 122 may be a customized card intended for use solely with electronic game system 100. Dedicated value bearing card 122 can be programmed to accept different amounts of value, and to authorize payment acceptance apparatus 106 to enable one or more plays on electronic game system 100. Dedicated value bearing card 122 may have a magnetic strip 126 or other machine processed apparatus so that it can be processed by payment acceptance apparatus 106 just like a bank-issued credit or debit card. Where this option is practiced, electronic game system 100 may comprise a device (shown representatively as slot 124 in FIG. 1) for entering value on value bearing card 122, and ejecting value bearing card 122. Dedicated value bearing card 122 may be utilized as an incentive by otherwise unrelated commercial organizations, for example.

The method may further comprise displaying an initial screen prior to the player taking action to initiate play, wherein the initial screen displays a first prompt asking the player whether the player wishes to play the game (step 202), and accepting inputs indicative of the player's desire to play the game by manipulation by the player of the same manual game play input apparatus as a user interface to respond to the first prompt (step 204). The first prompt is not shown, but may comprise an image of text inquiring whether the player wishes to play. This first prompt may be for example a default screen constantly displayed after conclusion of play, or alternatively may be activated by a proximity sensor (not shown), or by a person touching display screen 104 or joystick 116.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

The method may comprise, responsive to an affirmative reply to the first prompt, displaying a second prompt instructing the player to provide the value to pay for playing the game (step 206), and how to effect providing the value by utilizing same manual game play input apparatus as a user interface (step 208). That is, the second prompt may display text instructing the player to provide the value, and also text instructing the player how to accomplish that, using for example, joystick 116. Advantageously, joystick 116 (and pushbutton 117, when appropriate) may appear in imagery displayed on display screen 104 to supplement textual instructions.

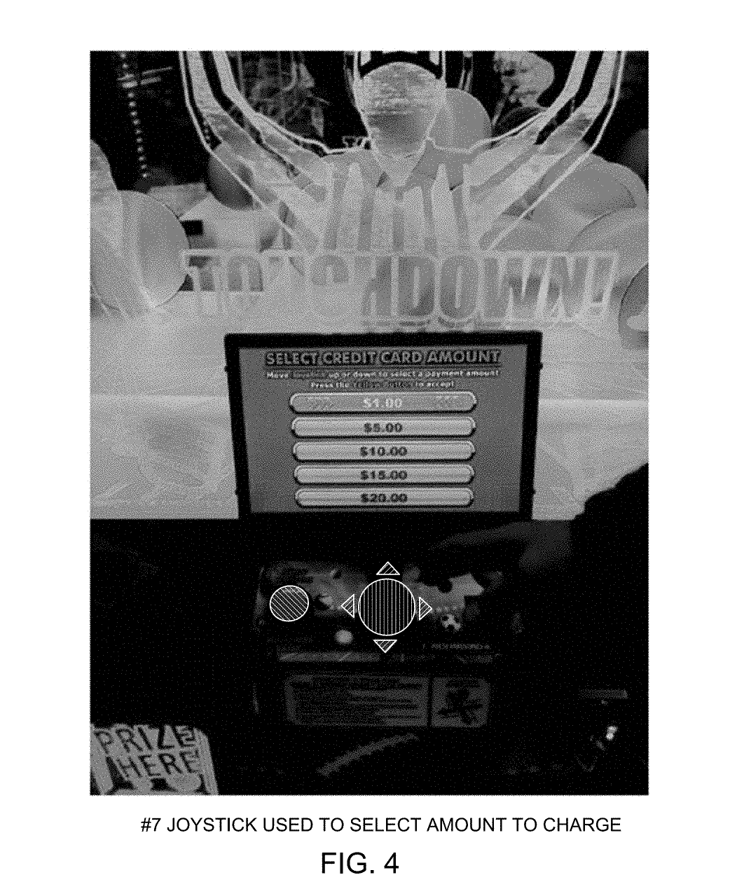

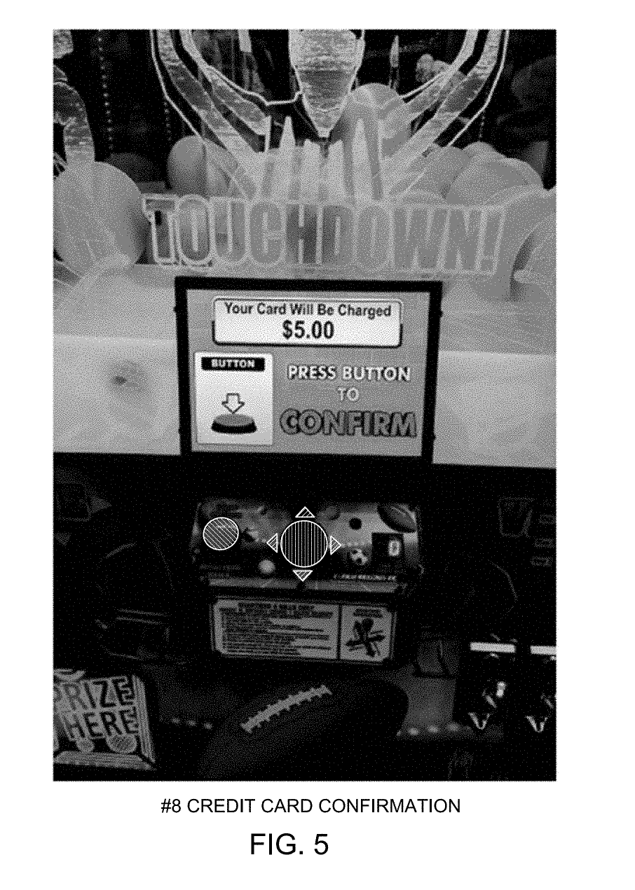

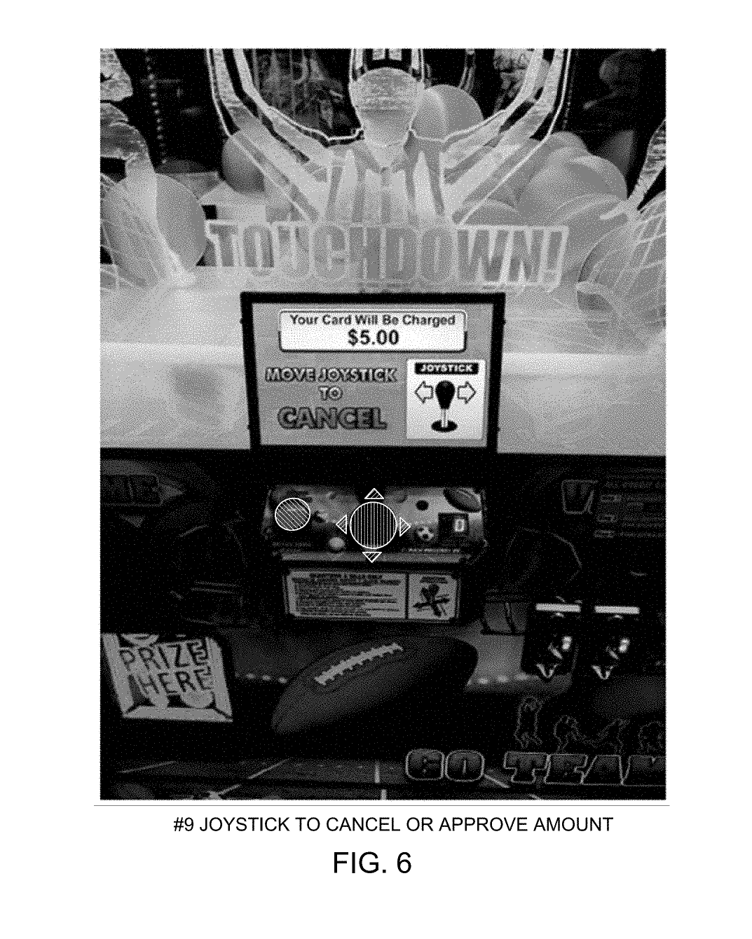

The role of display screen 104 in instructing the player to provide the value is illustrated in FIGS. 4 and 5. In FIG. 4, the player is prompted to select a desired credit card amount to be charged for play of the game. The player uses joystick 116 to select an amount (FIG. 4), and pushes pushbutton 117 (FIG. 5) to confirm the selected amount. In FIG. 6, the player is offered an option to cancel a previous selection, using joystick 116.

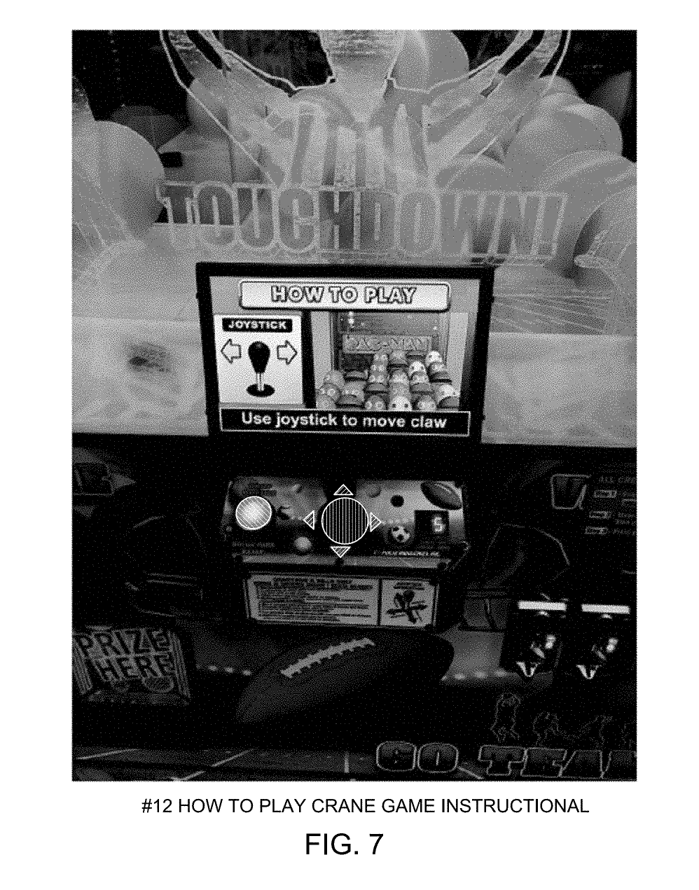

Note that in FIG. 7, the player uses the same joystick 116 to actually play the game, joystick 116 being used to control crane 110. Again, this may be reinforced by the appearance of joystick onscreen. There is therefore an immediate transition from the administrative tasks such as effecting payment to actual game play. There is no need for the player to reorient himself or herself from administrative controls, such as those used in the prior art only for payment acceptance apparatus 106, and become familiar with game play controls, since the same controls are used for both purposes.

The method may further comprise, responsive to an affirmative reply to the first prompt, displaying a third prompt inquiring how much value the player desires to transfer to the electronic game device (step 210). For example, there may be an option offering a discount for playing more than one game, in which case the amount of value transferred to electronic game system 100 may not correlate to whole number multiples of the charge for a single play or game.

The method may further comprise displaying a fourth prompt showing instructions on how to effect payment. Although this step is referred to previously as step 208, it is now clarified that step 208 may be practiced as issuing the fourth prompt. This option is ordinarily invoked when processing a debit or credit card (not shown), and may not be necessary in payment accepting apparatus 106 accepting cash.

The method may further comprise, responsive to an affirmative reply to the first prompt, displaying a fifth prompt instructing the player how to play the game after value has been accepted (step 218). As an alternative, the default initial image displayed on display screen 104 may include game instructions, as in some cases, the game instructions may act to entice a person to play the game.

The method may further comprise, responsive to the player playing the game, displaying a sixth prompt inquiring whether the player desires to take further action such as playing again (step 226). Optionally, if no response is received within a predetermined time interval, the image of display screen 104 may revert to an initial or default image.

The method may further comprise, responsive to an affirmative reply to the first prompt, displaying a seventh prompt presenting game play options. Ordinarily, these will include options such as selecting particular game rules or hypothetical situations within the game.

The method may further comprise, during play of the game, displaying game status including at least one of remaining time of play and credits issued (step 224). Credits issued may comprise points scored, in games having quantitative scores, or alternatively, prizes or other value accrued by virtue of skillful play of the game to the present point in time being reported.

The steps listed herein may occur in any feasible combination. Some of the steps may not be used in any particular method 200. Method 200 will, however, always include steps 212 and 222.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A method of operating an electronic game by a player, the electronic game having manual game play input apparatus for accepting player commands necessary to play the game, the method comprising:
utilizing the the manual game play input apparatus as a user interface to process inputs necessary to initiate game play; and
subsequently utilizing the same manual game play input apparatus as a user interface to play the game by having the player enter manual game move inputs to the manual game play input apparatus.

2. The method of claim 1, wherein processing inputs necessary to initiate game play comprises causing the electronic game to accept value in exchange for making the game available to a player, wherein causing the electronic game to accept value comprises utilizing the manual game play input apparatus to operate value acceptance by the electronic game device.

3. The method of claim 2, wherein causing the electronic game to accept value comprises processing one of a credit card and a debit card, utilizing the manual game play input apparatus as a user interface in processing the credit card or debit card.

4. The method of claim 1, further comprising issuing a dedicated value bearing card to the player.

5. The method of claim 1, further comprising:
displaying an initial screen prior to the player taking action to initiate play, wherein the initial screen displays a first prompt asking the player whether the player wishes to play the game; and
accepting inputs indicative of the player's desire to play the game by manipulation by the player of the same manual game play input apparatus as a user interface to respond to the first prompt.

6. The method of claim 5, further comprising, responsive to an affirmative reply to the first prompt, displaying a second prompt instructing
the player to provide the value to pay for playing the game; and
how to effect providing the value by utilizing same manual game play input apparatus as a user interface.

7. The method of claim 6, further comprising, responsive to an affirmative reply to the first prompt, displaying a third prompt inquiring how much value the player desires to transfer to the electronic game device.

8. The method of claim 6, further comprising displaying a fourth prompt showing instructions on how to effect payment.

9. The method of claim 5, further comprising, responsive to an affirmative reply to the first prompt, displaying a fifth prompt instructing the player how to play the game after value has been accepted.

10. The method of claim 1, further comprising, responsive to the player playing the game, displaying a sixth prompt inquiring whether the player desires to take further action such as playing again.

11. The method of claim 5, further comprising, responsive to an affirmative reply to the first prompt, displaying a seventh prompt presenting game play options.

12. The method of claim 5, further comprising, during play of the game, displaying game status including at least one of remaining time of play and credits issued.

13. An electronic game system for operating an electronic game by a player, the electronic game system comprising:
a game apparatus operable to enable the player to play a predetermined game;
manual game play input apparatus operating as an interface for receiving manual inputs corresponding to commands;
a display screen;
payment acceptance apparatus; and
a microprocessor including a memory having computer instructions loaded therein in a non-transitory computer-readable medium that when executed, are configured to instruct the microprocessor to
operate the game apparatus to play the game,
receive the manual inputs from the manual game play input apparatus,
control the display screen, and
operate the payment acceptance apparatus, wherein the same manual game play input apparatus which receives inputs to operate the game apparatus to play the game also receives inputs to operate the payment acceptance apparatus.

14. The electronic game system of claim 13, wherein the game apparatus comprises:
a play region containing at least one graspable free object; and
a crane configured and operable to reach into the play region and grasp and raise at least one said graspable free object.

15. The electronic game system of claim 13, further comprising a dispenser configured and operable to dispense a prize to the player, and wherein the computer instructions are configured to instruct the microprocessor to dispense the prize to the player when the player has attained a predetermined degree of success when playing the game.
